(19) United States
(12) Patent Application Publication
(10) Pub. No.: US 2009/0286163 A1
(43) Pub. Date: Nov. 19, 2009

(54) ELECTROLYTE MIXTURES USEFUL FOR LI-ION BATTERIES

(75) Inventors: Joon Ho Shin, San Jose, CA (US); Elton J. Cairns, Walnut Creek, CA (US)

Correspondence Address: LAWRENCE BERKELEY NATIONAL LABORATORY, Technology Transfer & Intellectual Propery Managem, One Cyolotron Road MS 56A-120, BERKELEY, CA, 94720, US

(73) Assignee: The Regents of the University of California, Oakland, CA (US)

(21) Appl. No.: 12/274,012

(22) Filed: Nov. 19, 2008

Related U.S. Application Data
(60) Provisional application No. 61/032,829, filed on Feb. 29, 2008.

(51) Int. Cl. H01M 6/18; H01M 4/58; H01M 4/82

(52) U.S. Cl. 429/315; 429/317; 429/314; 429/231.95; 29/623.1

(57) ABSTRACT

The present invention provides for the preparation of ionic liquid-lithium salt-low molecular weight liquid polymer mixtures. The mixture is useful as an electrolytic solution. Thus, the mixture is suitable as an electrolyte in batteries and supercapacitors as well as an active material for solid state light-emitting devices or polymer light-emitting displays or an electro deposition of alkali metals such as lithium, sodium, or potassium in the field of research or industry. The present invention further provides for a method making the mixture. Additionally, the present invention provides for a lithium battery comprising the mixture and a method of making the lithium battery.

### CROSS REFERENCE TO RELATED CASES

This application claims priority to U.S. Provisional Application Ser. No. 61/032,829, filed Feb. 29, 2008, which provisional application is incorporated herein by reference as if set forth in its entirety.

### STATEMENT OF GOVERNMENTAL SUPPORT

The invention described and claimed herein was made in part utilizing funds supplied by the U.S. Department of Energy (DOE) under Contract No. DE-AC02-05CH11231 through the DOE Laboratory Directed Research and Development (LDRD) program and the DOE Office of Basic Energy Sciences (BES). The government has certain rights in this invention.

### FIELD OF INVENTION

This invention relates to electrolytes for lithium ion batteries, and more particularly to a ternary electrolyte composition for use with lithium ion batteries, the electrolyte comprising an ionic liquid, a lithium salt and a glycol ether. These electrolyte compositions exhibit both relatively high ionic conductivity, as well as remarkably low viscosity, and improved thermal properties for use both with traditional disposable lithium batteries, and rechargeable lithium ion batteries employing Li electrodes, including such battery electrode cell combinations as Li/S, and Li/LiFePO₄.

### BACKGROUND OF THE INVENTION

Rechargeable lithium ion (Li-ion) batteries are being widely utilized as power sources especially in portable electronics such as mobile phones and laptop computers that require high energy density and long lifetime. However, commercial Li-ion batteries using conventional organic solvents such as ethylene carbonate (EC), diethyl carbonate (DEC) dimethyl carbonate (DMC), including mixtures thereof, and related volatile solvents as an electrolyte component have safety issues due to their high vapor pressure, high flammability, and poor thermal stability leading to decomposition, vaporization, and reaction (including combustion) of these organic solvents at fairly low temperatures (<100° C.). In addition, though the use of pure lithium metal as an electrode would be preferable due to its high specific capacity, lithium metal has not been adopted as an electrode in the organic solvent systems of the prior art due to its propensity to form dendrites which occurs during recharge. With the close spacing of electrodes (which in some cases may be as close as 25 microns), dendrites formed during recharge can ultimately reach across to the opposite electrode, resulting in shorts, and/or overheating.

Ionic liquids (ILs), more specifically room temperature ILs, which consist of an organic cation and an inorganic or organic anion, have been investigated over past decades for possible application as an electrolyte component in batteries, supercapacitors, and for example, polymer light-emitting electrochemical cells due to their well-known advantages of high ionic conductivity, non-flammability, low vapor pressure, wide electrochemical stability window and their environmentally benign nature. A problem when using these ionic liquids, however, is that though they are thermally stable, they have poor wetting capabilities, such that when used with more conventional anode electrodes such as carbon, tin, silicon, and aluminum [Li—C, Li—Sn, Li—Si, Li—Al] they tend to form films on the electrodes, resulting in high interfacial impedance.

Binary formulations of ionic liquids and lithium salts have been investigated by others. Also investigated has been IL-Li salt-organic solvent ternary mixtures, as well as IL-Li salt-polymer gels as electrolytes, the organic solvents the conventional, more flammable solvents of the prior art, such as ethylene carbonate, diethyl carbonate, and dimethyl carbonate. It was also found that the incorporation of N-methyl-N-alkyl pyrrolidinium bis(trifluoro methane sulfonyl)imide (PYRIRTFSI, where 1=methyl, R=an alkyl chain) ILs into conventional poly(ethylene oxide) (PEO)-based solid polymer electrolytes resulted in a significant improvement of ionic conductivity and cycling performance when used with Li/V₂O₅, and Li/LiFePO₄ electrode containing cells. However a drawback to these PEO based electrolytes is their low conductivity, which renders them unusable at room temperatures.

There presently exists a great deal of interest in the possible use of sulfur as a cathode material since elemental sulfur is able to deliver 1672 mAh/g, assuming that elemental sulfur is fully converted into Li₂S. This is the highest theoretical capacity among conventional cathode materials, but sulfur suffers from a high rate of capacity fading in combination with currently-used electrolyte systems, for example PEO-based polymer electrolyte or dioxolane-dimethoxy ethane-diglyme-sulfolane-1M LiCF₃SO₃ mixtures. There were recent reports on the use of ILs as an electrolyte component in a Li/S cell: dimethoxyethane/dioxolane (8/2 v/v)-imidazolium salts (9/1 v/v) ternary mixture; N-methyl-N-butyl piperidinium bis(trifluoro methane sulfonyl)imide-1M LiTFSI binary mixture. However, the reports of this work covering these ionic liquid-salt combinations provided data for only 10 cycles, far short of the hundreds upon hundreds required for commercially viable rechargeable batteries.

Although some report show better cycling performance of Li cells in IL-Li salt binary mixtures, in fact such electrolyte systems seem to be faced with an issue of high interfacial impedance at the Li metal electrode, which limits rate capability and long-term cycle life of Li cells. Katayama et al [1] demonstrated that Li metal in ionic liquid electrolytes forms a protective layer, and Howlett et al [2] reported that N-methyl-N-alkylpyrrolidinium bis(trifluoromethane sulfonyl)amide ionic liquid forms a passive layer on the Li metal surface greater than those with alkyl carbonates that contributes to high interfacial impedance. In a previous work by the inventors herein [3] it was found that a Li/S cell with poly(ethylene glycol) dimethyl ether (PEGDME) alone as the electrolyte was able to deliver above 100 mAb/g-electrode for 600 cycles at room temperature, demonstrating that PEGDME solvent is compatible with Li metal and the intermediates of the sulfur cathode.

### BRIEF SUMMARY OF THE INVENTION

The present invention provides a mixture useful as an electrolyte for lithium batteries and rechargeable lithium ion batteries. In one embodiment the mixture comprises a thermally stable ionic liquid, a low molecular weight polymer, and a lithium salt. The low molecular weight polymer acts herein as a solvent to solvate the lithium salt, and has good compatibility with lithium metal.

The present invention provides a mixture comprising a thermally stable ionic liquid; a low molecular weight polymer having an ethylene oxide chain; and a lithium salt. Suitable low molecular weight polymers include for example, polyethylene glycol dimethyl ether (PEGDME,), which polymers are mixed with ionic liquids such as PYR₁₄ TFSI [wherein subscript 1 denotes methyl, and subscript 4 denotes butyl], and a lithium based salt such as LiTFSI to form the electrolytes of this invention. These mixtures are suitable as an electrolytic solution for use in batteries and supercapacitors as well as an active material for solid state light-emitting devices or polymer light-emitting displays in the field of research or industry. The mixtures are also suitable for the electro deposition of reactive metals such as lithium, sodium and potassium.

The present invention further provides a method of making an electrolyte mixture comprising: (a) providing a thermally stable ionic liquid; (b) providing a polymer having an ethylene oxide chain; (c) providing a lithium salt; and (d) mixing the ionic liquid, the polymer, and the lithium salt.

The electrolyte of the present invention has been found to enable the use of pure lithium metal as a battery electrode material in rechargeable batteries. By enabling the use of pure lithium, significant weight reductions in the case of the negative electrode (the anode) can be achieved. In fact, weight savings of up to 80% of the active material of the negative electrode may be realized. In addition, it has been found that the ionic liquid electrolyte of this invention facilitates the use of sulfur as a cathode material. It also improves the safety and maintains the good performance of currently available battery cells that use conventional cathodes such as LiFePO₄, LiCoO₂, and the like.

The present invention also provides a lithium battery comprising: (a) a mixture, wherein the mixture comprises a thermally stable ionic liquid, a polymer having an ethylene oxide chain, a lithium salt; (b) a lithium negative electrode (preferably a lithium metal negative electrode); and (c) a positive electrode. The electrolytes of the invention greatly increase the safety of lithium batteries, as the electrolyte described herein is substantially non flammable. These thermally stable electrolytes don't decompose until they reach high temperatures in the range of 300-400° C. This compares to current electrolytes which decompose and/or react at temperatures approaching 120° C., and in fact may ignite at that temperature.

The present invention further provides for a device that utilizes a lithium battery comprising: (a) an electrolyte mixture, wherein the mixture comprises a thermally stable ionic liquid, a polymer having an ethylene oxide chain, a lithium salt; (b) a lithium containing negative electrode; and (c) a positive electrode.

The present invention also provides a method of making a lithium battery comprising: (a) providing an electrolytic mixture of a thermally stable ionic liquid, a polymer solvent having an ethylene oxide chain, and a lithium salt; (b) providing a positive electrode; (c) providing a lithium negative electrode; (d) providing a cell housing; and (e) assembling the mixture, the positive electrode and the lithium negative electrode into the cell housing. In one embodiment the positive electrode comprises sulfur, and in another embodiment it comprises LiFePO₄.

The electrolytes of the invention can be used with standard lithium-carbon electrodes, to provide safer, thermally stable systems. In addition they can especially be used with rechargeable lithium cells.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 depicts the chemical structure of: (a) poly(ethylene glycol) dimethyl ether (PEGDME) and (b) N-methyl-N-butyl-pyrrolidinium (PYR₁₄⁺) bis(trifluoro methane sulfonyl)imide (TFSI⁻).

FIG. 2 shows a thermogravimetric analysis (“TGA”) of PYR₁₄TFSI+0.5 m LiTFSI+y PEGDME mixture. The measurement was carried out at a heating rate of 10° C./min under a N₂ atmosphere. The y is the mass ratio of kg PEGDME/kg PYR₁₄TFSI.

FIG. 3 depicts differential scanning calorimetry (“DSC”) traces of the first heating scan of PYR₁₄TFSI+0.5 m LiTFSI+y PEGDME mixtures conducted at a scan rate of 10° C./min under a helium atmosphere. All the samples were subjected to a second heating scan under the same conditions, but here we only present the first heating scans. The y is the mass ratio of kg PEGDME/kg PYR₁₄TFSI. First the sample was quenched from room temperature to −130° C. using liquid nitrogen and maintained at −130° C. for about 30 minutes prior to the start of the measurement. The sample was loaded into an Al pan and scaled hermetically in a glove box filled with He.

FIG. 4 depicts an Arrhenius plot of the ionic conductivity of PYR₁₄TFSI+0.5 m LiTFSI+y PEGDME mixtures. Active area of stainless steel (SS) electrode: 0.9 cm². Frequency range: from 65 kHz to 10 Hz. The y is the mass ratio of kg PEGDME/kg PYR₁₄TFSI. The working temperature was raised from ambient temperature to about 90° C. and all cells were allowed to cool down to ambient temperature overnight in an oven, followed by cooling down to about −15° C. All cells were equilibrated at every temperature step for at least 30 minutes prior to AC impedance measurement.

FIG. 5 depicts interfacial impedance as a function of time for Li/PYR₁₄TFSI+0.5 m LiTFSI+y PEGDME/Li cells kept at 40° C. under open circuit conditions. The area of the Li electrode was 1.6 cm². The y is the mass ratio of kg PEGDME/kg PYR₁₄TFSI. The Li salt concentration in the PEGDME-LiTFSI mixture is 0.5 m LiTFSI/kg-PYR₁₄TFSI.

FIG. 6 depicts the anodic overpotential of symmetric Li/PYR₁₄TFST+0.5 m LiTFSI+y PEGDME/Li cells acquired from galvanostatic Li stripping/deposition at +0.2 mA/cm² at 60° C. Area of Li electrode: 1.6 cm². The y is the mass ratio of kg PEGDME/kg PYR₁₄TFSI. The PEGDME-LiTFSI mixture contains Li salt of 0.5 m LiTFSI/kg-PEGDME.

FIG. 7 depicts selected overpotential profiles of a symmetric Li/PYR₁₄TFSI+0.5 m LiTFSI+y PEGDME (y=1.5)/Li cell during galvanostatic Li stripping/deposition at ±0.2 mA/cm² at different temperatures: 30° C. (from the 1^{st} to 15^{th} cycle); 40° C. (from the 16^{th} to 45^{th} cycle). Area of Li electrode: 1.6 cm². The y is the mass ratio of kg PEGDME/kg PYR₁₄TFSI.

FIG. 8 depicts discharge capacities of Li/S cells with PYR₁₄TFST+0.5 m LiTFSI+y PEGDME electrolytes cycled at ±0.054 mA/cm² at 40° C. The y is a mass ratio of kg PEGDME/kg PYR₁₄TFSI. Sulfur cathode composition: CS1 (see Table 3). Active area of electrodes: sulfur cathode (0.9 cm²), Li anode (1.6 cm²). Loading of active material: 2.6 mg (y=0), 0.8 mg (y=1.0), 1.1 mg (y=1.5), 1.3 mg (y=2.0). Cut-off voltages: 1.5<V<3.3. All cells were cycled in a glove box filled with He.

FIG. 9 depicts voltage profiles of a Li/S cell with PYR₁₄TFSI+0.5 m LiTFSI+y PEGDME (y=1.5) electrolyte cycled at 0.054 mA/cm² at 40° C. The cell with y=1.5 of FIG. 8 was reassembled after 100 cycles using a fresh Li metal electrode and electrolyte (y=1.5). The y is the mass ratio of kg PEGDME/kg PYR₁₄TFSI. Sulfur cathode composition: CS1 (see Table 3). Active area of electrodes: sulfur cathode (0.9 cm²), Li anode (1.6 cm²). Loading of active material: 1.1 mg. Cut-off voltage: 1.5<V<3.3. The cell was cycled in a glove box filled with He.

FIG. 10 depicts discharge capacity vs. cycle number of a Li/PYR₁₄TFSI+0.5 m LiTFSI+y PEGDME (y=2.0)/S cell tested at −1.0° C. The y is the mass ratio of kg PEGDME/kg PYR₁₄TFSI. Sulfur cathode composition: CS2 (see Table 3). Active area of electrodes: sulfur cathode (0.9 cm²), Li anode (1.6 cm²). Loading of active material: 1.6 mg. Cut-off voltage: 1.5<V<3.3. The cell was kept overnight at working temperature (−1.0° C.) under open circuit prior to cycling.

FIG. 11 depicts selected voltage profiles of a Li/PYR₁₄TFSI+0.5 m LiTFSI+y PEGDME (y=2.0)/S cell conducted at various currents at −1° C. presented in FIG. 10: 0.05 mA (31.3 mA/g-sulfur), 0.03 mA (18.8 mA/g-sulfur), 0.015 mA (9.4 mA/g-sulfur). The y is the mass ratio of kg PEGDME/kg PYR₁₄TFSI. Sulfur cathode composition: CS2 (see Table 3). Active area of electrodes: sulfur cathode (0.9 cm²), Li anode (1.6 cm²). Loading of active material: 1.6 mg. Cut-off voltage: 1.5<V<3.3.

FIG. 12 depicts selected voltage profiles of a Li/PYR₁₄TFSI+1.5 m LiTFSI+y PEGDME (y=2.0)/S cell measured at 0.05 mA/cm² at room temperature. The y is the mass ratio of kg PEGDME/kg PYR₁₄TFSI. Sulfur cathode composition: CS2 (see Table 3). Active area of electrodes: sulfur cathode (0.9 cm²), Li anode (1.6 cm²). Loading of active material: 1.3 mg. Cut-off voltage: 1.5<V<3.3.

FIG. 13 depicts an Arrhenius plot of viscosity (μ) as a function of temperature for PYR₁₄TFSI+LiTFSI+polymer additive (PEGDME, MW 250 or TEGDME, MW 178) ternary electrolytes. The viscosity data were obtained using a heating scan from about 30° C. to 80° C. with steps of 10° C. Compositions: 0.3 moles LiTFSI/kg (polymer additive+IL). Mass ratio of polymer additive: IL=1:1. The data for PYR₁₄TFSI were taken from Tokuda et. al. [19].

FIG. 14 depicts an Arrhenius plot of ionic conductivity as a function of temperature for PYR₁₄TFSI+LiTFSI+polymer additive (PEGDME or TEGDME) ternary electrolytes. This graph was plotted using the data reported in our previous publications [9,10]. Squares: 0.5 moles LiTFSI/kg IL; circles: 0.25 moles LiTFS/kg (polymer additive+IL); diamonds: 0.1 moles LiTFSI/kg (polymer additive+IL). Mass ratio of polymer additive: IL=1:1.

FIG. 15 (a) depicts the cycling performance of Li/PYR₁₄LiTFSI+LiTFSI+polymer additive (PEGDME or TEGDME)/LiFePO₄ cells tested at charge/discharge cut-off voltages of 2<V<4 and FIG. 15 (b) continuous cycling behavior of a Li/PYR₁₄LiTFSI+LiTFSI+PEGDME/LiFePO₄ cell tested at 2<V<3.7 at room temperature. Current (0.2 C rate): 0.052 mA/cm² for PEGDME, 0.044 mA/cm² for TEGDME; Loading of active material: 1.53 (PEGDME), 1.26 mg/cm² (TEGDME).

FIGS. 16(a) and (b) depict selected voltage profiles of a Li/PYR₁₄TFSI+LiTFSI+TEGDME/LiFePO₄ cell tested at charge/discharge cut-off voltages of 2<V<4 in 16(a) and 2<V<3.7 in 16(b), at room temperature. Current (0.2 C rate): 0.044 mA/cm². Loading of active material: 1.26 mg/cm²).

FIG. 17(a) depicts the discharge capacity vs. number of cycles and FIG. 17(b) the voltage profile for the 2^{nd} cycle for a Li/PYR₁₄TFSI+LiTFSI+TEGDME/LiFePO₄ cell tested at 0.023 mA/cm² at −1.0° C. Loading of active material: 1.35 mg/cm². Charge/discharge cut-off voltage: 2<V<4.

### DETAILED DESCRIPTION OF THE INVENTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

The terms anode and cathode as commonly used in battery literature can be confusing and misleading, particularly in connection with rechargeable batteries. A more correct designation is negative electrode or positive electrode. The negative electrode corresponds to what is usually called the anode. The positive electrode corresponds to what is usually called the cathode. Accurately speaking, the negative electrode is only an anode (the electrode at which an oxidation reaction is taking place) during the discharge process. During recharge, the negative electrode operates as a cathode (the electrode at which a reduction reaction is taking place). Correspondingly, the positive electrode operates as a cathode during discharge only. During recharge, the positive electrode operates as an anode. Thus, as used throughout this application, the terms negative and positive electrodes are employed and are to be read consistent with the terminology of this paragraph.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It should be noted that as used herein and in the appended claims, the singular forms “a”, “and”, and “the” include plural referents unless the context clearly dictates otherwise. Thus, for example, reference to “polymer” includes a plurality of such polymers, and so forth.

These and other objects, advantages, and features of the invention will become apparent to those persons skilled in the art upon reading the details of the invention as more fully described below.

### Ionic Liquid-Li Salt-Polymer Solvent Mixtures

The present invention provides for the preparation of ionic liquid-lithium salt-polymer mixtures. In some embodiments, the mixture comprises a thermally stable ionic liquid, a dimethyl ether polymer and a lithium salt.

In some embodiments, the mixture is useful as an electrolytic solution. Thus, in some embodiments, the mixture is suitable as an electrolyte in batteries and supercapacitors as well as an active material for solid state light-emitting devices or polymer light-emitting displays in the field of research or industry. This electrolytic solution is also suitable for the electro deposition of reactive metals such as lithium, sodium and potassium.

The mixture provides one or more of the following advantages as compared to Li-ion batteries using conventional organic solvents or Li-ion batteries using IL-PEO based electrolytes: 1) increased ionic conductivity, 2) low viscosity, 3) improved compatibility with lithium (“Li”) metal, 4) improved Li stripping/deposition cyclability, 5) improved charge/discharge cyclability of Li metal batteries, 5) lower cell impedance due to lower interfacial impedances, 6) lower temperature charge/discharge capability and 7) improved safety over conventional organic-liquid non-aqueous electrolytes due to the lower vapor pressure and lower flammability.

Ionic conductivity (σ) is the ability to transfer a current by the movement of ions. Ionic conductivity can be determined by use of the following equation in combination with experimental measurements of resistance:

σ=l/(R×A)

where R is resistance of bulk electrolyte which can be measured by AC impedance methods, l is the thickness of the electrolyte, and A is the active area of the electrodes. Typical solid polymer electrolytes have an ionic conductivity of ˜10⁻⁵ S/cm at room temperature. Further, IL-PEO based electrolytes have an ionic conductivity of 4×10⁻⁴ S/cm at 20° C. Thus, an increased ionic conductivity can be characterized as a value of a greater than 4×10⁻⁴ S/cm at 20° C.

The present invention further provides for a mixture comprising a thermally stable ionic liquid; a polymer having an ethylene oxide chain, and a lithium salt. In some embodiments, the mixture comprises a mass ratio of the polymer to the ionic liquid of about 0.01 to about 10.0.

In one embodiment, the electrolyte comprises a mixture having the formula:

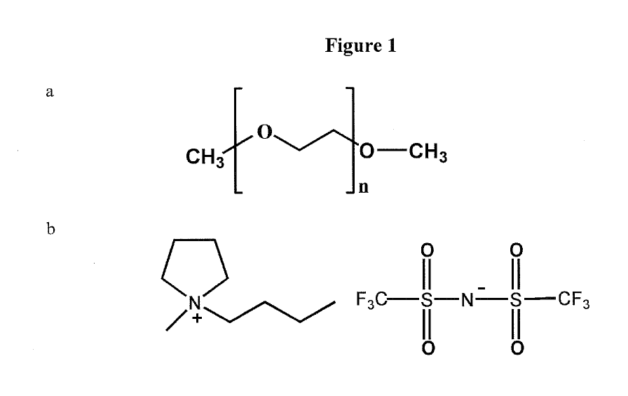

PYR₁₄TFSI+x LiTFSI+y PEGDME,

where PYR₁₄TFSI is the ionic liquid N-methyl-N-butyl-pyrrolidinium bis(trifluoro methane sulfonyl)imide whose chemical structure shown in FIG. 1(b), LiTFSI is the lithium salt, PEGDME is poly(ethylene glycol) dimethyl ether whose chemical structure shown in FIG. 1(a), x is the ratio of moles of LiTFSI to kg of PYR₁₄TFSI, and y is the mass ratio of kg of PEGDME to kg of PYR₁₄TFSI. In some embodiments, x has a value of 0.1 m to 3.0 m. In some embodiments, y has a value of 0.1 to 3.0.

In some embodiments, the PYR₁₄TFSI/LiTFSI/PEGDME mixture has an ionic conductivity that is equal to or more than about 2.9×10⁻³ S/cm at 29° C. depending on the concentration of the polymer. Whereas, ionic conductivity of the PYR₁₄TFSI-LiTFSI mixture only, i.e. without the polymer, was 1.7×10⁻³ S/cm at 30° C. (see Table 4).

The present invention also provides for a method of making an electrolytic solution comprising: (a) providing a thermally stable ionic liquid; (b) providing a polymer having an ethylene oxide chain; (c) providing a lithium salt; and (d) mixing the ionic liquid, the polymer, and the lithium salt.

In some embodiments, the mixture is suitable for use as an electrolytic solution for a battery having one or more battery cells when coupled with a negative electrode and a positive electrode.

### Ionic Liquids

One aspect of the present invention provides that the mixture comprises an ionic liquid. An ionic liquid is a salt in which the ions are bulky and poorly coordinated, which results in these solvents being liquid at temperatures below 100° C., or even at room temperature (room temperature ionic liquids). At least one ion has a delocalized charge and generally at least one component is organic, which prevents the formation of a stable crystal lattice. Room temperature ionic liquids (RTILs) are molten salts at room temperature that generally comprise an organic cation and an inorganic or organic anion. Some of the advantages of RTILs in comparison to organic solvents are: non-flammability, negligible vapor pressure, and chemical and thermal stability. For example, N-methyl-N-butyl pyrrolidinium bis(trifluoro methane sulfonyl)imide (“PYR₁₄TFSI”), whose chemical structure is shown in FIG. 1(b), is a synthesized room temperature ionic liquid.

In some embodiments, the ionic liquid comprises an organic cation and an inorganic anion.

### Organic Cations for Use in Ionic Liquids

In some embodiments, the organic cation suitable for the ionic liquid has a high ionic conductivity, is thermally stable and has a wide electrochemical stability window.

Thermal stability refers to the ability of a compound to maintain its physical properties when exposed to high or low temperatures, or when exposed to large fluctuations in temperature. It is the compound's thermal characteristic. Below the thermal decomposition temperature, the compound remains stable at certain temperatures. Beyond that temperature, if the compound is exposed to higher than decomposition temperature, it degrades. For organic materials, the decay rate increases with temperature. Organic materials with a greater thermal stability will remain unchanged at high temperature independent of exposure time. The thermal stability of the electrolyte, and therefore the organic cation, is a crucial issue relating to safety in Li ion batteries. Thus, it is optimal to use organic cations that are thermally stable.

Electrochemical stability refers to the ability of a compound to maintain its electrochemical properties, e.g. not degrade, when exposed to a wide range of potentials, e.g.—when tested at 1V to 6V using a reference Li/Li⁺ cell.

In some embodiments, the organic cation has a bulky asymmetrical structure. In some embodiments, the organic cation is a nitrogen-containing ring structure with alkyl side chains.

In some embodiments, the organic cation is one of the following or a mixture thereof: N-methyl-N-alkyl-pyrrolidinium, N-methyl-N-alkyl-pyridinium, N-methyl-N-alkyl-piperidinium, N-methyl-N-alkyl-imidazolium, N-methyl-N-alkyl-phosphonium, N-methyl-N-alkyl-ammonium, N-methyl-N-alkyl-guanidinium, or N-methyl-N-alkyl-isouronium, wherein alkyl refers to homologous series with the general formula CₙH₂ₙ₊₁. Examples include, but are not limited to, methyl, CH₃.; ethyl, C₂H₅.; propyl, C₃H₇.; butyl, C₄H₉.; pentyl, C₅H₁₁.; hexyl, C₆H₁₃.; heptyl, C₇H₁₅.; octyl, C₈H₁₇.; nonyl, C₉H₁₉.; decyl, C₁₀H₂₁.; undecyl, C₁₁H₂₃.; and dodecyl, C₁₂H₂₅.

### Anions for use in Ionic Liquids

In some embodiments, the anions used in ion liquids may be inorganic. In other embodiments they may also be organic. In one embodiment the inorganic anion is an imide. Imide anions have large electron delocalization and low melting temperature. Thus, in some embodiments, the inorganic anion is one of the following or a mixture thereof: bis(trifluoro methane sulfonyl)imide or bis(perfluoro ethyl sulfonyl)imide.

In some embodiments, the anion is an amide, which includes, but is not limited to, bis(trifluoro methane sulfonyl)amide.

In other embodiments, the anion is one of the following or a mixture thereof: trifluoromethanesulfonate, hexafluorophosphate, tetrafluoroborate, or tetraperchlorate. Trifluoromethanesulfonate is a functional group with the formula CF₃SO₃⁻. Trifluoromethanesulfonate is an extremely stable polyatomic ion, being the conjugate base of triflic acid (CF₃SO₃H), one of the strongest acids known. Hexafluorophosphate is an anion with chemical formula of PF₆⁻. Tetrafluoroborate is an anion with the chemical formula BF₄⁻. Perchlorate is an anion with the chemical formula ClO₄⁻.

### Polymer

An aspect of the present invention is that the mixture includes a low molecular weight polymer. The concentration of polymer depends upon its molecular weight. In some embodiments, the polymer has a weight-average molecular weight of about 75 to about 2000. In some embodiments the polymer has a weight-average molecular weight of about 100 to about 1000. In some embodiments, the polymer has a weight-average molecular weight of about 250 to about 500.

The concentration of polymer utilized in the mixture depends upon the amount of ionic liquid. Thus, in some embodiments, the mass ratio of the polymer to the ionic liquid is about 0.01 to about 10.0.

In some embodiments, the polymer is a glyme. Glymes, or glycol diethers, are some of the most powerful solvents available today for an incredibly wide variety of industrial processes and products including lithium salts. Glymes are saturated polyethers with no functional groups; hence, they are aprotic compounds that are relatively inert chemically. These features account for their excellent solvent properties. Additionally, by using glymes, there is no phase separation between the ionic liquid and polymer. This all-ether stricture produces only weak associations between glyme molecules and is responsible for the low viscosity of these materials, an important plus in many applications, such as the low-viscosity component of the solvent for electrolytes of lithium batteries.

In some embodiments, the polymer is poly(ethylene glycol) dimethyl ether (also known as polyglyme or PEGDME), whose chemical structure is shown in FIG. 1(a). PEGDME with a molecular weight (Mₙ) of 100 to 1000 or an average Mₙ of 100 to 2000 is suitable for use (available from Fluka/Sigma Aldrich, Switzerland). In the experiments reported below, commercially available PEGDME with a MW of 250 was used.

In some embodiments, the polymer is tetra(ethylene glycol) dimethyl ether (also known as tetraglyme or TEGDME). In some embodiments, the polymer is tri(ethylene glycol) dimethyl ether (also known as triglyme). Generally, suitable ethers include those that are liquid at room temperature and have a conductivity of between 10⁻² and 10⁻⁴.

### Lithium Salt

Another aspect of the present invention is that the mixture comprises a lithium salt. Any soluble lithium salt may be used in the present invention. In some embodiments, lithium salts having good ionic conductivity due to a low lattice energy (i.e. a high degree of dissociation), and high thermal stability and oxidation resistance may be used in the present invention. The lithium salts can be used alone or in selective mixture forms. Table 2 provides some lithium salts that are suitable for the electrolyte mixture of the present invention.

TABLE 2
Examples of Lithium Salts

| Salt | Formula |
|---|---|
| Lithium Hexafluorophoshate | LiPF₆ |
| Lithium Tetrafluoroborate | LiBF₄ |
| Lithium Hexaflouroarsenate | LiAsF₆ |
| Lithium Trifluoromethane Sulfonate | LiCF₃SO₃ |
| Lithium Iodide | LiI |
| Lithium Bis(Trifluoromethanesulfonyl)Imide | LiN(CF₃SO₂)₂ |
| (LiTFSI) | |
| Lithium Bis(Perfluoroethylsulfonyl) Imide | LiN(CF₃CF₂SO₂)₂ |
| Lithium Perchlorate | LiClO₄ |
| Lithium Bis(Oxalato) Borate | LiB(C₂O₄)₂ |
| Tetraethylammonium Tetrafluoroborate | (C₂H₅)₄NBF₄ |
| Triethylmethylammonium Tetrafluoroborate | (C₂H₅)₃CH₃NBF₄ |

In some embodiments, the concentration of lithium salt depends on the amount of ionic liquid. In some embodiments, the moles of lithium salt per kg of ionic liquid ranges from about 0.01 to about 3.0. Preferably, the moles of the lithium salt to kg of ionic liquid is ˜0.5.

### Lithium Battery

In an embodiment of the invention, a lithium battery is assembled, the battery including: (a) an electrolytic solution, wherein the electrolytic solution comprises a thermally stable ionic liquid, a low molecular weight polymer having an ethylene oxide chain, and a lithium salt; (b) a lithium metal negative electrode; and (c) a positive electrode. In another embodiment the positive electrode can be sulfur (wherein the sulfur is mixed with a carbon powder for electronic conductivity, and a polymer binder to hold the structure together). In still another embodiment the positive electrode can be LiFePO₄ (mixed with a carbon powder and a polymer binder), this material attractive for use as an electrode due to its low cost, non-toxicity, its thermal stability, and high specific capacity (170 mAh/g). Such LiFe PO₄ cathodes are particularly well suited for use with the ternary electrolytes of this invention; in one embodiment the mass ratio of polymer additive to PYR14TFSI being 1:1. In addition to the above, the assembled batteries include a metal foil current collector to conduct current to and from the positive and negative electrodes.

A method for making a lithium battery according to one aspect of the invention comprises: (a) providing an electrolytic solution comprising a thermally stable ionic liquid, a low molecular polymer having an ethylene oxide chain, a lithium salt; (b) providing a positive electrode; (c) providing a lithium negative electrode; (d) providing a cell housing; and thereafter (e) assembling the electrolytic solution, the positive electrode and the lithium negative electrode into the cell housing. In one embodiment the ethylene oxide containing polymer solvent used in the electrolyte of the invention is PEGDME and in another embodiment it is TEGDME.

In some embodiments, the lithium negative electrode (the anode in discharge mode), is lithium metal supported on a stainless steel (SS) foil or other suitable material. In some embodiments, the negative electrode is a lithium-containing material such as lithium in carbon Li(C), LiC₆, Li—Si, Li—Al, Li—Sn, or mixtures thereof. In some embodiments, the positive electrode is sulfur, a metal oxide, a metal phosphate, a mixture thereof, or any other suitable material. In some embodiments, the compositions of the sulfur cathodes are those as listed in Table 3. In some embodiments, the metal phosphate used for the cathode is LiFePO₄.

The cell housing used in these experiments is a modified Swagelok® fitting (available from URL: <http://www.swagelok.com>, Solon, Ohio).

The present invention further provides for a device that utilizes a lithium battery comprising: (a) an electrolytic solution, wherein the electrolytic solution comprises a thermally stable ionic liquid, a low molecular weight polymer having an ethylene oxide chain, and a lithium salt; (b) a lithium negative electrode; and (c) a positive electrode.

### EXPERIMENTAL EQUIPMENT AND PROCEDURES

### Example 1

### Electrolyte Preparation

Materials. [N-methyl-(n-butyl)pyrrolidinium]⁺[bis(trifluoromethanesulfonyl)imide]^{- (PYR}₁₄TFSI, see FIG. 1 for chemical structure) ionic liquid salt is synthesized and is dried at about 130° C. overnight in a vacuum oven before use. Elemental sulfur (sublimed sulfur powder, Alfa Johnson Matthey), carbon black (Shawinigan black, 50% compressed) and poly(vinylidene fluoride) (PVDF, Kynar) are dried in a vacuum oven overnight at 50, 130 and 90° C., respectively, before use.

Electrolyte preparation. Poly(ethylene glycol) dimethyl ether (PEGDME, Fluka, Molecular weight=250, of the chemical structure presented in FIG. 1) is passed through a column filled with alumina (MP Alumina N-Super I, MP Biomedicals Germany GmbH) to obtain dry polymer with limited H₂O (˜30 ppm) level before use. A number of PYR₁₄TFSI+x LiTFSI+y PEGDME mixtures were then prepared for which x was of the value of 0.5 m (moles per kg) of PYR₁₄TFSI, and where y had the values of 0.1, 1.0, 1.5 and 2.0 kg PEGDME per kg of PYR₁₄TFSI. Once combined, the blends were stirred gently overnight on a magnetic hot-plate at ambient temperature. The electrolyte preparations were carried out in a glove box filled with helium.

### Example 2

### Preparation of the Sulfur Cathode, Assembly and Testing

Sulfur cathode preparation. First, sulfur powder suspended in ˜15 ml of N-methylpyrrolidone (dried through a column filled with alumina, NMP, H2O content of 30 ppm determined by Karl Fisher Coulometer (Mettler Toledo DL39)) is ball milled for 1 hour (referred to as CS1) or 6 hours (referred to as CS2) at a rotation speed of 200 rpm using a planetary mono mill (PMM, Pulverisette 6, Fritsch) and then carbon black, PVDF (polyvinylidene fluoride) binder and LiTFSI are added to the ball-milled sulfur suspension and this mixture is ball milled for an additional 1 hour (CS1) or 2 hours (CS2) under the same conditions. The resulting slurry is coated onto a carbon-coated Al foil substrate using a doctor blade. The solvent is allowed to evaporate overnight at ambient temperature. The resulting cathode film (ca 50 μm thick) is used to prepare the cathodes by punching circular discs having an area of 0.9 cm². These discs are dried at ˜40° C. under vacuum in the presence of P₂O₅ (Aldrich, 97%) for at least 2 days before use. All the procedures for cathode (i.e. positive electrode) preparation were conducted in a solvent-processing glove box filled with helium. The cathode composition and conditions for planetary milling are presented in Table 3.

TABLE 3
Compositions of Sulfur Cathodes

| | | | | | | | Initial discharge capacity | |
|---|---|---|---|---|---|---|---|---|
| | Sulfur | Carbon | PVDF | LiTFSI | t_{PMM} | D_{sulfur} | (mAh/g-sulfur)*** | |
| | (Wt. %) | (Wt. %) | (Wt. %) | (Wt. %) | (hour) | (μm) | 29(±1)° C. | −1(±1)° C. |
| CS1* | 66.8 | 22.4 | 8.8 | 2.0 | 2 | 28 | 326 | — |
| CS2** | 66.7 | 22.4 | 8.9 | 2.0 | 8 | 15 | 1304 | 391 |

t_{PMM} indicates time for planetary mono milling. D_{sulfur} indicates sulfur particle size at 50 v/o determined by particle size analysis after ball milling of the slurry.
*Sublimed sulfur in CS1 is used as received.
**Sublimed sulfur in CS2 is sieved through 400 mesh (37 μm).
***The initial discharge capacity is obtained from Li/S cells with PYR₁₄TFSI + 0.5 m LiTFSI + y PEGDME (y = 2.0) electrolyte tested at 0.054 mA/cm².

Cell assembly and characterization. The thermal behavior and physical properties of PYR₁₄TFSI+x LiTFSI+y PEGDME mixtures are examined using differential scanning calorimetry (DSC, DSC 7, Perkin Elmer) over a temperature range of −130° C. to 100° C. with a heating and cooling rate of 10° C./min under flow of N₂, and thermogravimetric analysis (TGA, TGA 7, Perkin Elmer) is performed at a heating rate of 10° C./min from 30° C. to 600° C. under flow of H₂.

A symmetric SS/electrolyte/SS conductivity test cell is used for ionic conductivity measurements, a Li/electrolyte/Li test cell is used for interfacial impedance measurements and galvanostatic polarization measurements, and a Li/electrolyte/S battery type cell is used for cell performance and cycling measurements. All of these cells are assembled using a Swagelok cell housing. The separators used are a microporous polypropylene membrane (Celgard 2400) for Li/Li cells and Li/S cells, and a 265 μm thick polypropylene film is used in the SS/electrolyte/SS conductivity cells. The Li metal compatibility with the mixed electrolyte is characterized through AC impedance analysis over a frequency range of from 65 kHz to 0.01 Hz with an amplitude of 5 mV using a Solartron model 1254 in combination with Electrochemical Interface SI1286 and galvanostatic Li stripping/deposition polarization measurements at current density of 0.1-0.2 mA/cm² using a battery cycler (Arbin, BT-2042). The charge and discharge capability of Li/electrolyte/S [hereinafter also referred to as Li/S] cells is characterized by galvanostatic charge/discharge over a voltage range of 1.5 V to 3.3 V using the battery cycler. All of the cell preparation and charge/discharge cycling are carried out in a solvent-free glove box filled with helium.

### Example 3

### Ionic Liquid, Polymer, Lithium Salt Mixture for Li/S cells

The addition of a low molecular weight polymer t such as PEGDME (e.g., as a component of a PYR₁₄TFSI+LiTFSI+PEGDME mixture) results in improved compatibility of the ionic liquid electrolyte containing PEGDME with a Li metal electrode, which allows for low temperature operation at a moderate current density and longer cycle life of the Li electrode in a battery containing such electrolytes. In particular, a lithium/sulfur battery containing the electrolyte mixture PYR₁₄TFSI+LiTFSI+PEGDME reveals improved cyclability and low temperature charge/discharge capability.

A ternary mixture, PYR₁₄TFSI+x LiTFSI+y PEGDME (x is LiTFSI mol/PYR₁₄TFSI-kg and y is the mass ratio of PEGDME/PYR₁₄TFSI), is used as an electrolyte in Li/S cells. The physical and electrochemical properties of the mixture as well as the charge and discharge capability of Li/S cells is also characterized using these mixtures as the electrolyte at various temperatures.

Electrolytes are prepared comprising a mixture of PYR₁₄TFSI+0.5 m LiTFSI+y PEGDME (y=kg PEGDME/kg PYR₁₄TFSI) with various PEGDME contents from y=0.1 to y=2.0, which are then characterized and employed in Li/S cells. The presence of PYR₁₄TFSI in the mixture results in a significant improvement of thermal stability and ionic conductivity. The ionic conductivity of the mixture increases remarkably with increasing PEGDME contents (for example, for y=2.0, σ=4.2×10⁻³ S/cm at 29° C.). The conductivity increase is particularly significant at low temperatures, and is due to a lowering of the viscosity of the mixture with higher amounts of PEGDME. It is found that the mixture has good compatibility with Li metal electrodes as demonstrated by time-dependent interfacial impedance and galvanostatic Li stripping/deposition measurements. Li/S (CS2) cells in PYR₁₄TFSI+0.5 m LiTFSI+y PEGDME (y=2.0) can deliver about 1300 mAh/g-sulfur at 0.054 mA/cm² at ambient temperature on the first cycle. A better charge/discharge cyclability of Li/S cells with PYR₁₄TFSI+0.5 m LiTFSI+y PEGDME is found at higher PEGDME contents, and the Li/S cell with the mixture having y=2.0 exhibited a capacity fading rate of 0.42%/day for over 100 cycles at 0.054 mA/cm² at 40° C. The PYR₁₄TFSI+LiTFSI+PEGDME mixtures as demonstrated by these results are suitable electrolytes for Li/S cells.

### Example 4

### Results and Discussion for Li/S Cells

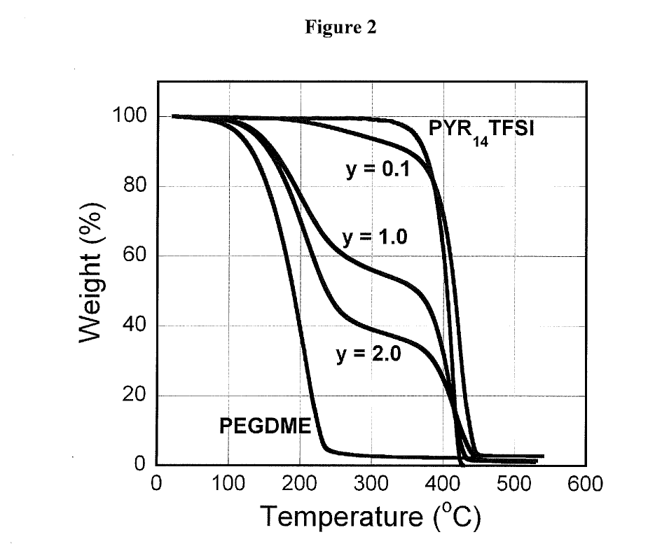

The thermal stability of the electrolyte is a crucial issue relating to safety in Li ion batteries. FIG. 2 shows a thermogravimetric analysis detailing the thermal stability of PYR₁₄TFSI+0.5 m LiTFSI+y PEGDME mixtures. The temperatures corresponding to a 5% weight loss for the mixtures are listed in Table 4. Neat ionic liquid PYR₁₄TFSI appeared to be thermally stable up to 300° C. with less than 1% weight loss. A weight loss of 5% was observed at 359° C. that is similar to that (374° C.) of N-methyl-N-ethyl imidazolium TFSI [4]. It was found that pure PEGDME exhibits relatively lower thermal stability showing a 1% weight loss at 71° C. and weight loss of 3% at 100° C. The addition of LiTFSI salt (0.5 mol/kg-PEGDME) to pure PEGDME resulted in slightly improved thermal stability compared to pure PEGDME and a 3% weight loss of the PEGDME+0.5 m LiTFSI/kg-PEGMDE mixture was observed at about 107° C. For y=0.1, the mixture appeared to be highly stable with <1.5% weight loss at 200° C. The mixture with y=2.0 exhibited 1% weight loss at 94° C. and demonstrated a relatively good thermal stability. The thermal stability of PYR₁₄TFSI+0.5 m LiTFSI+y PEGDME mixtures is dependent on the amount of PEGDME and lower PEGDME contents in the mixture resulted in better thermal stability of the mixture.

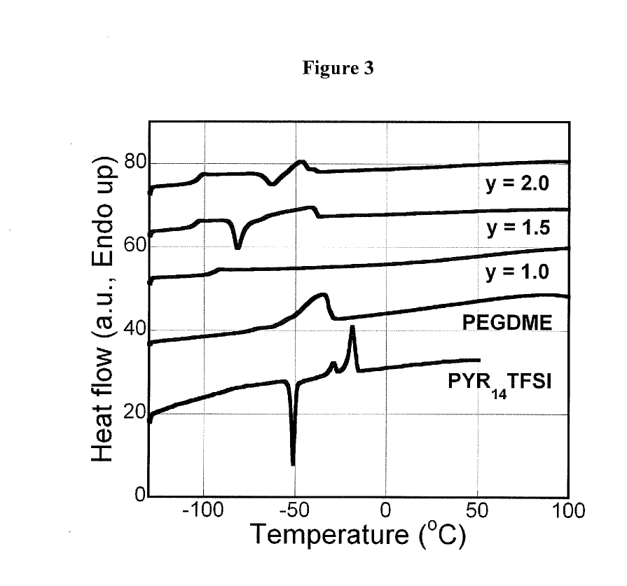

FIG. 3 presents the differential scanning calorimetry (DSC) results for PYR₁₄TFSI+0.5 m LiTFSI+y PEGDME mixtures for the temperature range from −130° C. to 100° C. The phase transition and glass transition temperatures of the mixtures attained are listed in the Table. 4.

TABLE 4
Physical properties of PYR₁₄TFSI + 0.5 m LiTFSI + y PEGDME mixtures

| y (kg PEGDME/ | σ (mS/cm)/ | | | | |
|---|---|---|---|---|---|
| kg PYR₁₄TFSI) | T (° C.) | T_{g} (° C.) | T_{c} (° C.) | Tₘ (° C.) | **T_{5% weight loss}(° C.) |
| 0 | 1.7/30 | −75 | −24 | 7 | 378 |
| 0.1 | 2.9/29 | — | — | — | 276 |
| 1.0 | 3.8/29 | −93 | — | — | 140 |
| 1.5 | 3.5/29 | −105 | −81 | −41 | — |
| 2.0 | 4.2/29 | −104 | −62 | −47 | 135 |
| PYR₁₄TFSI* | 3.6/30 | −90* | −51 | −8 | 359 |
| PEGDME | — | — | — | −35 | 113 |

*The T_{g} of PYR₁₄TFSI was attained from the 2^{nd} heating scan at DSC.
**T_{5%} _{weight loss} indicates the temperature resulting 5% weight loss in TGA measurement.

During the first heating scan from −130° C. to 100° C. neat PYR₁₄TFSI ionic liquid exhibited a sharp exothermic peak (T_{c1}, phase transition from liquid to phase I) at −51° C. and a metastable phase transition from phase I to phase II at −29° C. (T_{g}) and a melting peak of phase II at −18° C. (Tₘ₂) which agrees well with the thermal behavior of identical ionic liquid observed by MacFarlane et al., [5] and on the second heating scan the glass transition (T_{g}) at −90° C. and the melting peak of phase II at −8° C. (Tₘ₂) shifting toward a higher temperature was observed (not shown here). Henderson et al. [6] found a different thermal phase behavior for an identical ionic liquid salt depending upon the thermal history of the sample. Only an endothermic peak at −3° C. was observed as the salt was annealed at −15° C. prior to measurement. For pure PEGDME a broad endothermic peak at −35° C. was found. No phase transition peaks were observed for the mixture with y=1. However, both y=1.5 and y=2.0 showed an exothermic phase transition at 81° C. and 62° C., respectively, and for y=1.5 the exothermic peak was not observed on subsequent heating whereas the appearance of the exothermic peak was repeatable in subsequent heating scans for the mixture with y=2.0. Observations are made additionally as follows: (i) none of the exothermic (T_{c1}) and endothermic peaks (Tₘ₁ and Tₘ₂) of neat PYR₁₄TFSI were observed in the DSC trace of PYR₁₄TFSI+0.5 m LiTFSI+y PEGDME mixtures; (ii) an endothermic peak of PEGDME located at −35° C. was only found in the mixtures of higher PEGDME content above y=1.5, which shifts toward lower temperatures with increasing PEGDME contents; (iii) the glass transition temperature of neat PYR₁₄TFSI positioning at −90° C. was lowered to −105° C. with increasing PEGDME contents in the mixture.

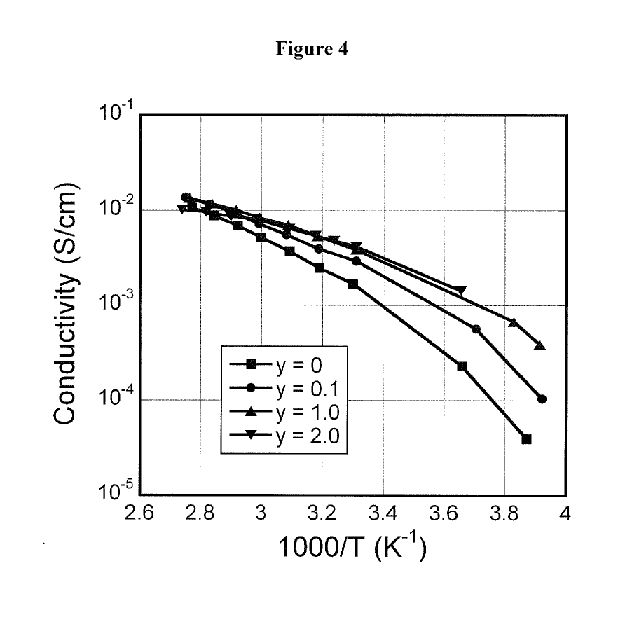

FIG. 4 displays the ionic conductivity of PYR₁₄TFSI+0.5 m LiTFSI+y PEGDME mixtures. The addition of small amounts of PEGDME (y=0.1) to the mixture resulted in a remarkable increase of the ionic conductivity when compared to that of PYR₁₄TFSI+0.5 m LiTFSI (y=0), particularly at low temperatures (<30° C.). The increase of ionic conductivity was apparent with increasing PEGDME contents up to y=1.0 and no substantial increase of ionic conductivity of the mixture with higher PEGDME contents up to y=2.0 was found over entire temperature range studied. The ionic conductivity of y=2.0 was 4.2×10⁻³ S/cm at 29° C. which is comparable to those of organic solvent-based electrolytes, for example diethyl carbonate (DEC)+40 mol % propylene carbonate (PC)+LiTFSI (molar ratio of mixed solvent: salt=20:1) at 30° C. [7]. In particular the mixture showed fairly high ionic conductivity at low temperatures: 1.3×10⁻³ S/cm at 4.6° C. for y=1.5 and 1.4×10⁻³ S/cm at 0.5° C. for y=2.0. Such a significant increase of ionic conductivity of the mixture is attributed to the lowering of viscosity by addition of PEGDME solvent to the PYR₁₄TFSI+0.5 m LiTFSI mixture.

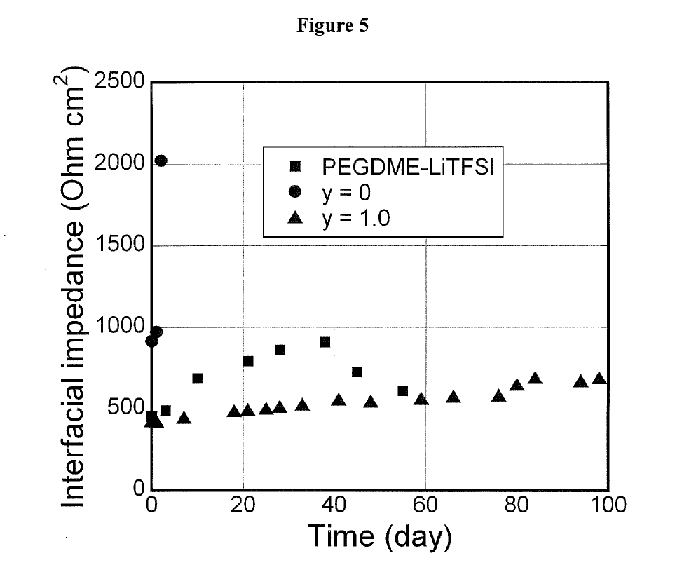

Symmetric Li/Li cells in PYR₁₄TFSI+0.5 m LiTFSI+y PEGDME mixtures are operated at 40° C. under open circuit and the interfacial impedance as a function of time is investigated using an AC impedance analyzer. FIG. 5 shows the behavior of the interfacial impedance of the Li/Li cells with PYR₁₄TFSI+0.5 m LiTFSI+y PEGDME electrolytes. It is notable that PYR₁₄TFSI+0.5 m LiTFSI, y=0, exhibits fairly high interfacial impedance and a steep rise of interface impedance is observed within a few days whereas the interfacial impedance of PEGDME+LiTFSI mixtures increases slowly and steadily over about 40 days, followed by a decrease over the following 20 days. The interfacial impedance stabilizes over 150 days (not shown in FIG. 5), which demonstrates good compatibility of the PEGDME+LiTFSI mixture with Li metal. The Li/Li cell with the mixture having y=1.0 shows a steady increase of interfacial impedance over the entire storage time of 109 days with a rate of about 3.6 Ω-cm²/day, and the mixed electrolyte exhibits an excellent compatibility with Li metal at moderate temperatures over three months under open circuit conditions. In conclusion, the presence of PEGDME in the mixture results in better compatibility of the mixture toward Li metal and the optimal compatibility is observed in the presence of both PYR₁₄TFSI and PEGDME.

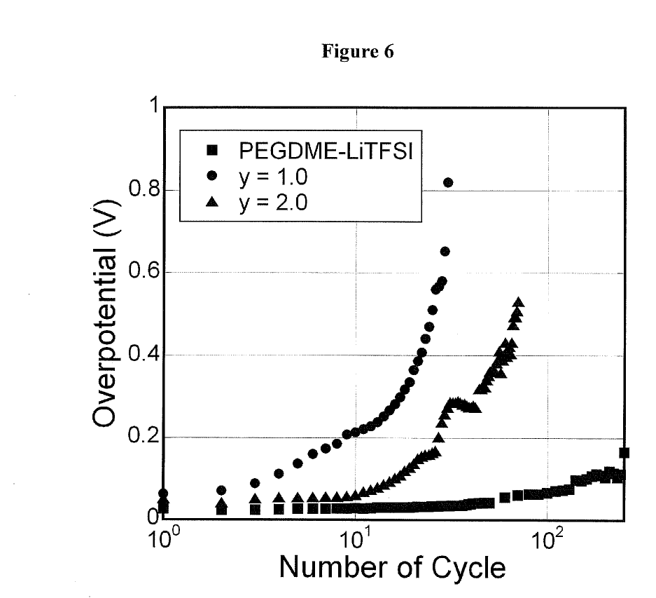

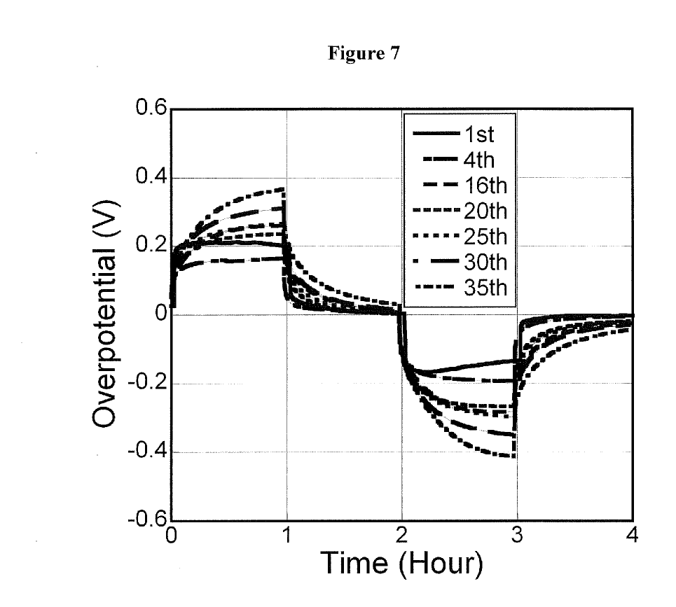

FIG. 6 displays anodic overpotential vs. number of cycles for Li/PYR₁₄TFSI+0.5 m LiTFSI+y PEGDME/Li test cells cycled at ±0.334 mA at 60° C. The cell is held at constant current for 1 hour at 0.334 mA and allowed for rest for 1 hour followed by passage of current in the opposite direction for 1 h at −0.334 mA, followed by a rest period of 1 hour. As shown in FIG. 7 a symmetric overpotential behavior is observed. It is notable that a Li/Li cell in PYR₁₄TFSI+0.5 m LiTFSI (y=0) electrolyte shows a drastic increase of overpotential (reached more than 1.5 V within an hour) at 0.334 mA at 60° C. which may be attributed to a fast-growing interfacial impedance for the PYR₁₄TFSI+0.5 m LiTFSI electrolyte in contact with Li metal as demonstrated by the impedance analysis discussed above (see also FIG. 5) whereas the Li/Li cell with the PEGDME+LiTFSI mixture exhibits relatively low overpotential (<0.2 V) at 0.334 mA at 60° C. for more than 260 cycles. The PEGDME+LiTFSI mixture results in the optimal Li stripping/deposition cycling performance, and the Li/Li cell in PYR₁₄TFSI+0.5 m LiTFSI+y PEGDME electrolytes shows a lower overpotential and better cycling performance with increasing PEGDME contents up to y=2.0.

FIG. 7 presents overpotential profiles of a Li/Li cell with PYR₁₄TFSI+0.5 m LiTFSI+y PEGDME (y=1.5) carried out at +0.167 mA at different temperatures. It is apparent that the Li stripping and deposition profile is symmetric and both polarization profiles show a rapid increase of overpotential immediately after applying the current and reached a constant level of overpotential. The total overpotentials increased up to ±0.4 V over 35 cycles, which is attributed to the increasing interfacial impedance of the cell as demonstrated by AC impedance analysis (not shown here). The time to reach a steady-state overpotential on cycling appears to become longer with increasing numbers of cycles, and during the rest periods the relaxation of the concentration gradient formed during current flow takes place more slowly with increasing numbers of cycles. This may be the result of increasing viscosity of the electrolyte with continuing cycling.

To investigate the behavior of these electrolyte mixtures in Li/S cells for use in batteries, two kinds of sulfur cathodes (referred to as CS1 and CS2) composed of nearly identical compositions only having different sulfur particle sizes as reported in Table 3 are used. The sulfur cathode CS1 with the larger sulfur particle size exhibits a lower initial capacity than CS2 with smaller particle size. Note that the PYR₁₄TFSI+0.5 m LiTFSI+y PEGDME mixture has no phase separation, and neither the sulfur cathode nor separator has wetting issues (that are apparent with the IL alone) with the mixture.

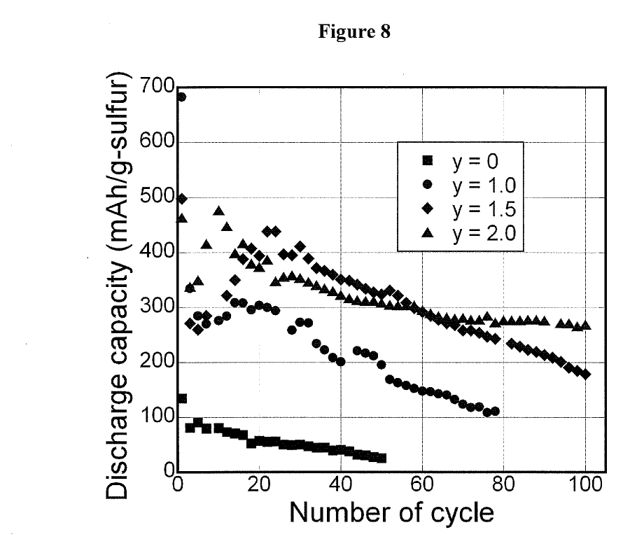

FIG. 8 exhibits the charge/discharge behavior of Li/S cells with PYR₁₄TFSI+0.5 m LiTFSI+y PEGDME electrolytes tested at 0.054 mA/cm² at 40° C. The Li/S cell with PYR₁₄TFSI+0.5 m LiTFSI (y=0) electrolyte exhibits a very low discharge capacity, corresponding to sulfur utilization (=delivered capacity×100/theoretical capacity of sulfur) of 8.1%, for the first cycle as compared to PYR₁₄TFSI+0.5 m LiTFSI+y PEGDME mixture electrolyte and a relatively high rate capacity fading of 1.62%/cycle, defined as (capacity at 1^{st} cycle-capacity at last cycle)×100/number of cycle, over 50 cycles was observed, which is higher than those of Li/S cell with PYR₁₄TFSI+0.5 m LiTFSI+y PEGDME mixture, showing capacity fading rate of 1.31, 0.69 and 0.42%/cycle for y=1.0, y=1.5 and y=2.0, respectively. The cell with y=1.0 shows higher initial discharge capacity than those of the cells with y=1.5 and y=2.0, but a rapid capacity fading is observed in the subsequent few cycles, followed by an increase of discharge capacity up to 20 cycles and a large decay of capacity is found over the 80 cycles. The cells with y=1.5 and y=2.0 exhibit a similar trend of capacity with a lower rate of capacity fade depending upon the PEGDME contents mentioned above. It is apparent that the cell with y=2.0 showed very reversible charge/discharge behavior from the 60^{th} cycle to the 100^{th} cycle at which point the cell is able to deliver about 269 mAb/g-sulfur (179 mAh/g-electrode), corresponding to about 16% of the theoretical capacity. Consequently, Li/S cells with ternary mixtures of PYR₁₄TFSI+0.5 m LiTFSI+y PEGDME electrolyte containing higher PEGDME contents demonstrated a better charge/discharge cyclability at moderate temperature.

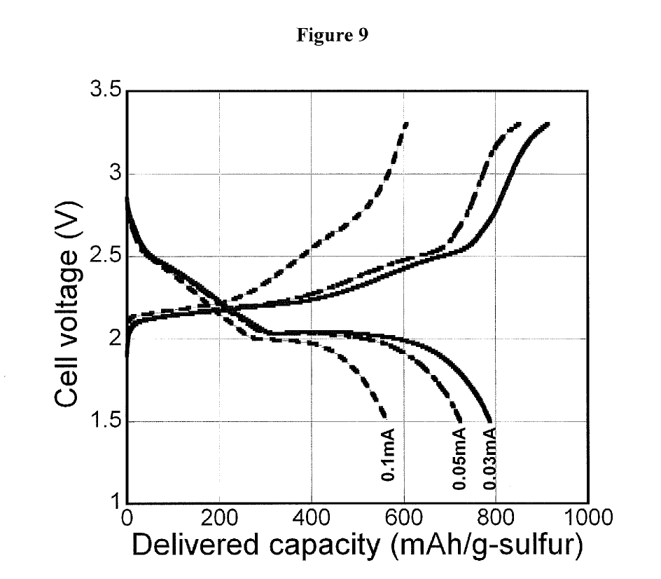

After the 100th cycle of the cell with y=1.5 presented in FIG. 8 the sulfur cathode is removed from the cell and reassembled with a fresh Li anode, separator and the electrolyte of y=1.5, and then tested under identical conditions at 0.054 mA/m² at 40° C. It is of interest to note that the cell delivers about 720 mA/hg-sulfur for the first discharge that is higher than the initial discharge capacity (498 mAh/g-sulfur) of as assembled cell shown in FIG. 8 and exhibits a good reversible cyclability up to 10 additional cycles showing 723 mAh/g-sulfur at the tenth discharge. In subsequent cycles the current density is varied and FIG. 9 shows a few selected charge/discharge profiles of the reassembled Li/PYR₁₄TFSI+0.5 m LiTFSI+y PEGDME (y=1.5)/S cell carried out at current densities of 0.033, 0.054, 0.11 mA/cm² at 40° C. Note that the original cell shown in FIG. 8 exhibits a very short discharge plateau at 2.0 V. However, the reassembled cell in FIG. 9 shows a prolonged charge and discharge plateau at 2.0 V (referred to as the lower plateau) and 2.4 V (referred to as the higher plateau), respectively. The cell delivers about 300 mAh/g-sulfur for the upper discharge plateau independent of current density whereas the discharge capacity of the lower plateau appeared to be dependent on current density. The lower current densities results in longer lower plateaus, demonstrating that lithium sulfide (Li₂S) is more effectively formed at low current densities at moderate temperatures. It is of great importance to point out that the sulfur cathode maintains its active material (elemental sulfur) over long-term cycling indicating that intermediate polysulfides are compatible with these ternary mixtures PYR₁₄TFSI-LiTFSI-PEGDME and that capacity fading of the Li/S cell may be correlated with the mechanical degradation of the sulfur cathode such as either poor electric contact between sulfur particles and carbon particles or agglomeration of carbon nano particles rather than loss of polysulfide or lithium sulfide into the electrolyte.

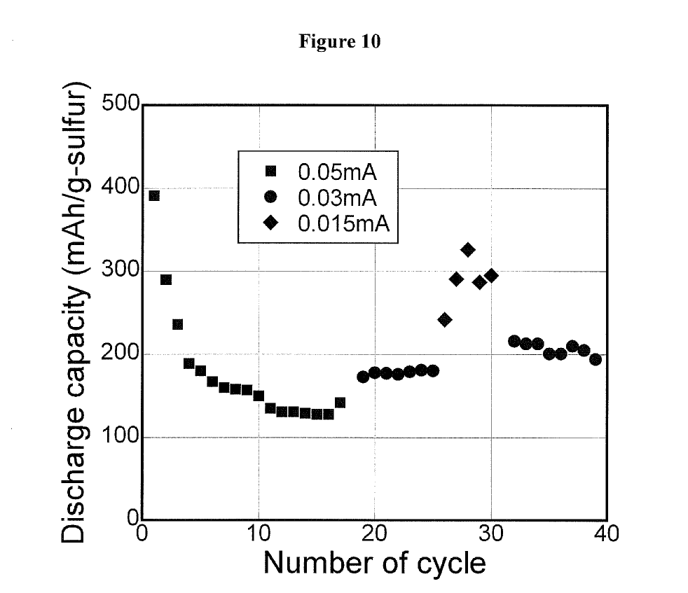

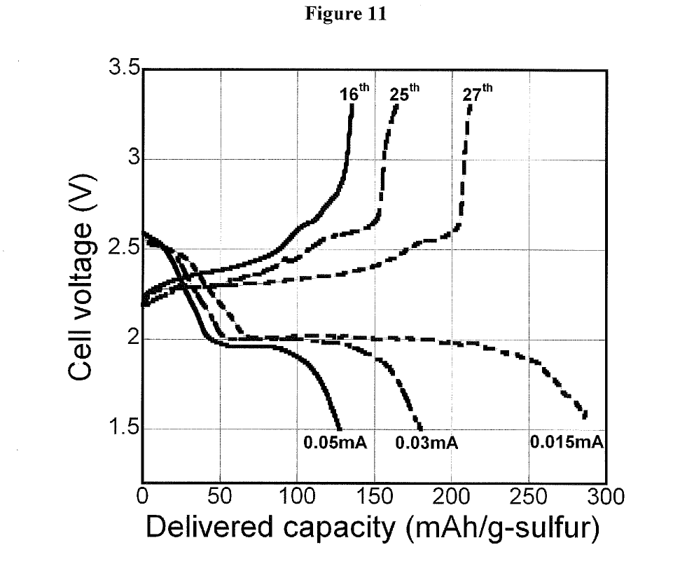

The low temperature cyclability of Li/S cells with PYR₁₄TFSI+0.5 m LiTFSI+y PEGDME (y=2.0) is presented in FIG. 10. The cell is able to deliver about 400 mAb/g-sulfur at −1.0° C. for the first discharge, followed by a rapid capacity decay in a few cycles, and in subsequent cycles the cell exhibits a constant capacity behavior. The initial discharge capacity of the cell at a high current density of 0.054 mA/cm², corresponding to 31.3 mA/g-sulfur, appears to be comparable to the first discharge capability (approximately 900 mAh/g-sulfur) of a Li/S cell with tetra ethylene glycol dimethyl ether electrolyte containing 0.5 m LiTFSI measured at 0° C. at low specific current of 10 mA/g-sulfur [8] since the cell in FIG. 10 is tested at three times higher current than that of Ref. [8]. The discharge capacity increases accordingly as current density decreased and is apparently constant at each current density. The cell exhibits a constant capacity of about 130 (at the 16^{th} cycle), 180 (at the 25^{th} cycle) and 290 mAh/g-sulfur (at the 30^{th} cycle) at 0.05, 0.03 and 0.015 mA, respectively, and we observe that in subsequent cycles the cell shows a better discharge capability compared to those observed in previous cycles at 0.03 mA. The influence of current density on charge and discharge behavior is shown in FIG. 11. At 0.03 mA the upper plateau is definitely prolonged compared to that at 0.05 mA and a remarkable extension of the lower discharge plateau is found at 0.015 mA. These results may imply that lithium polysulfide formation (Li₂Sₙ, n=8) is more efficient at low current density (˜0.0112 C) at low temperature, and lithium sulfide is effectively formed at a very slow discharge rate (C/180). An interesting observation is therefore that the rate of formation of lithium polysulfide and lithium sulfide in Li/S cells is strongly affected by operating temperature.

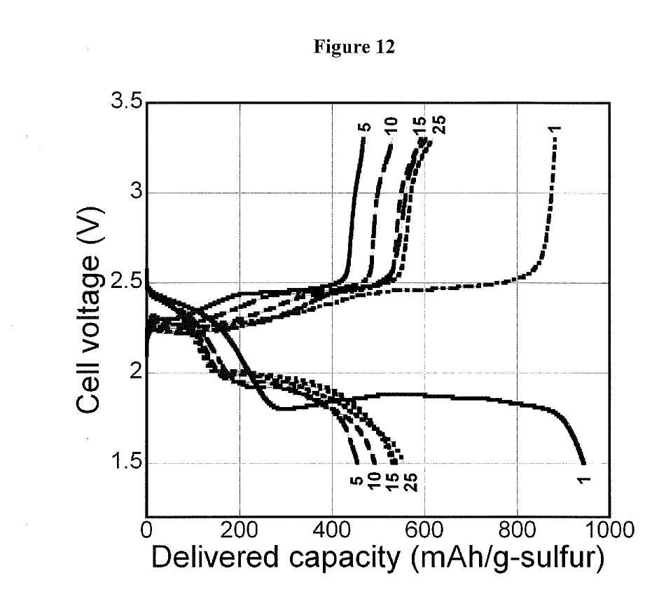

The charge and discharge profiles of a Li/S cell with PYR₁₄TFSI+1.49 m LiTFSI+y PEGDME (y=2.0) electrolyte tested at 0.054 mA/cm² at room temperature are presented in FIG. 12. The first discharge profile shows a lower discharge plateau in the vicinity of 1.8 V that is somewhat lower than the 2.0 V of a typical lower discharge plateau (see FIGS. 9 and 11) for different electrolytes (for example PEO-[9] or PVDF-based electrolyte [10]), which may be attributed to the higher Li salt concentration leading to a higher viscosity of the electrolyte. The lower plateau is observed at about 2V in following cycles. It is of interest that the cell was able to deliver 945 mAh/g-sulfur (i.e. 56.6% of the theoretical capacity) for the first discharge which is higher than the 45% utilization of a sulfur cell with PEGDME+LiTFSI electrolyte measured at 0.05 mA/cm² at room temperature [11]. At the second cycle a rapid capacity decay occurs, but the capacity increases steadily in subsequent cycles up to 20 cycles, followed by a constant discharge capacity behavior up to 25 cycles.

The above results demonstrate the capability of the compositions of this invention, e.g. PYR₁₄TFSI+LiTFSI+y PEGDME (y=kg PEDGME/kg PRY14TFSI) with various PEDGME contents from y=0.1 to 2.0) as electrolytes for Li/S cells. The presence of PYR₁₄TRFSI in the mixture results in a significant improvement of thermal stability and ionic conductivity. The ionic conductivity of the mixture increases remarkably with increasing PEGDME content. The conductivity increase is particularly significant at low temperatures, and this is probably due to a lowering of the viscosity of the mixture with higher amounts of PEGDME. It has been found that the mixture has good compatibility with Li metal electrodes as demonstrated by time-dependent interfacial impedance and galvanostatic Li stripping/deposition measurements. It was also found that Li/S cells with PYR₁₄TFSI+0.5M LiTFSI+y PEGDME (y=2) can deliver about 1300 mAhg⁻¹ sulfur at 0.054 mAcm⁻² at ambient temperature on the first cycle. Better charge/discharge cyclability of Li/S cells was found at higher PEGDME contents, and the Li/S cell with the mixture having y=2.0 exhibited a capacity fading rate of 0.42% per cycle for over 100 cycles at 0.054 mScm⁻² at 40° C.

### Example 5

### Ionic Liquid, Polymer, Lithium Salt Mixture for Li/LiFePO₄ Cells

The same electrolyte as used in example one was synthesized according to the same procedures as described in Example 1. More particularly, N-Methyl-N-butylpyrrolidinium bis(trifluoromethane sulfonyl)imide (PYR₁₄TFSI, see FIG. 1 for chemical structure) ionic liquid was synthesized and dried at 130° C. overnight in a vacuum oven before use. All chemicals and materials were properly dried before use. PYR₁₄TFSI+x LiTFSI+y polymer additive (poly(ethylene glycol) dimethyl ether (PEGDME) and tetra(ethylene glycol) dimethyl ether (TEGDME)) ternary electrolytes were prepared for which x had a value of 0.3 mol per kg of electrolytic solution (PYR₁₄TFSI+polymer additive), and y had a value of 1.0 kg of polymer per 1.0 kg of PYR₁₄TFSI, and the mixture was stirred gently overnight with a magnetic stirrer at ambient temperature.

Viscosity measurements were carried out on a Brookfield LVDF Pro-II+ Cone-Plate Viscometer equipped with a CPE40 spindle. Approximately 0.5 ml of the electrolyte was placed in the sample chamber coupled to a circulating bath and allowed to equilibrate at the set temperature. The equilibration time allowed was 30 minutes and the temperature was controlled within ±0.1° C. Measurements were done in the temperature range of 30-80° C. at an interval of 10° C.

The composite LiFePO₄ cathode film was prepared as follows: LiFePO₄ (50.1 wt. %, Hydro Quebec), carbon black (30.1 wt. %), and polyvinylidene fluoride (19.8 wt. %, Kynar 2801) along with LiTFSI (Aldrich) and PYR₁₄TFSI in 1:4 mass ratio, and as 25% of the electrode solids were suspended in N-methylpyrrolidone and stirred magnetically overnight. The resulting slurry was coated onto carbon-coated Al foil. The solvent was allowed to evaporate overnight at ambient temperature. The resulting cathode film (approximately 50 μm thick) was dried at ˜40° C. under vacuum in the presence of P₂O₅ (Aldrich, 97%) for 2 days before use. The ionic liquid with LiTFSI dissolved filled the pores of the electrode. All the procedures above were conducted in a solvent-process glove box filled with helium. A Li/LiFePO₄ cell was assembled where the Li electrode was lithium metal, and the cell housing a Swagelok cell housing in which a microporous polypropylene membrane (Celgard 2400) was used as a separator. The cycling performance of the Li/LiFePO₄ cells was characterized by galvanostatic charge/discharge using a battery cycler (Arbin, BT-2042). The charge/discharge procedure was carried out as follows: charge to 3.7V (or 4.0V) vs. Li/Li⁺; rest for 1 hour at open circuit; discharge to 2.0V (vs. Li/Li⁺); rest for 1 hour at open circuit. All of the cell preparation and charge/discharge cycling were carried out in a solvent-free glove box filled with helium.

### Results and Discussion

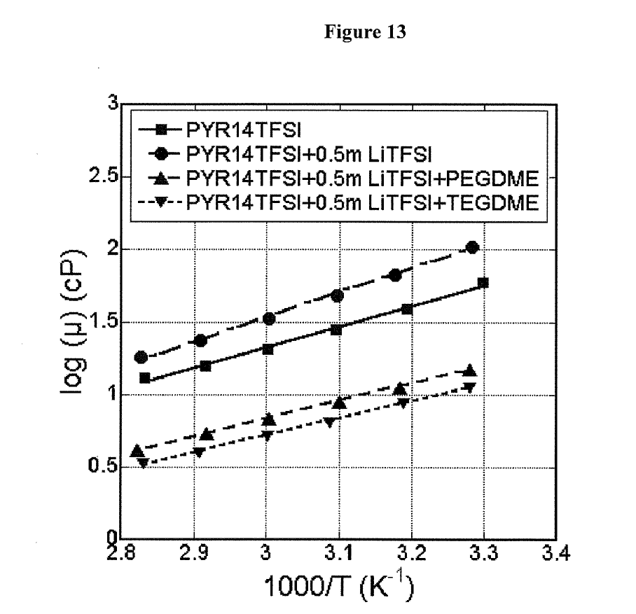

FIG. 13 presents the viscosity behavior as a function of temperature ranging from about 30° C. to 80° C. for the ternary electrolytes and the viscosity of polymer additive-free PYR₁₄TFSI+LiTFSI binary mixtures is presented for comparison. Tokuda et al. reported viscosity data of neat PYR₁₄TFSI as a function of temperature from 10° C. to 80° C. [12], and their data are included in FIG. 2. It is clear that PYR₁₄TFSI+LiTFSI binary mixtures have significantly higher viscosity than the ternary electrolytes containing polymer additive (PEGDME and TEGDME) over the entire temperature range suggesting that the polymer additive plays a crucial role in reducing the viscosity of PYR₁₄TFSI+LiTFSI binary mixtures. In addition, we observed that the viscosity of the ternary electrolytes is lower with increasing amounts of the polymer additive (not shown here). Saint et al observed that the capacity of the 1^{st} cycle in Li/PYR₁₃FSI-LiTFSI/LixMnO₂ cells is lower than for the following cycles, which might be due to delayed wetting of the composite cathode by the electrolyte [13]. We also observed that the PYR₁₄TFSI+LiTFSI binary mixture appears to wet the LiFePO₄ electrode poorly, whereas the ternary electrolyte wetted the cathode well during cell preparation. The incorporation of polymer additive into the PYR₁₄TFSI+LiTFSI binary mixtures resulted in lowering the activation energy for viscosity as follows: 33.8 kJ/mol for PYR₁₄TFSI+LiTFSI; 23.4 kJ/mol for PYR₁₄TFSI+LiTFSI+PEGDME; 22.7 kJ/mol for PYR₁₄TFSI+LiTFSI+TEGDME.

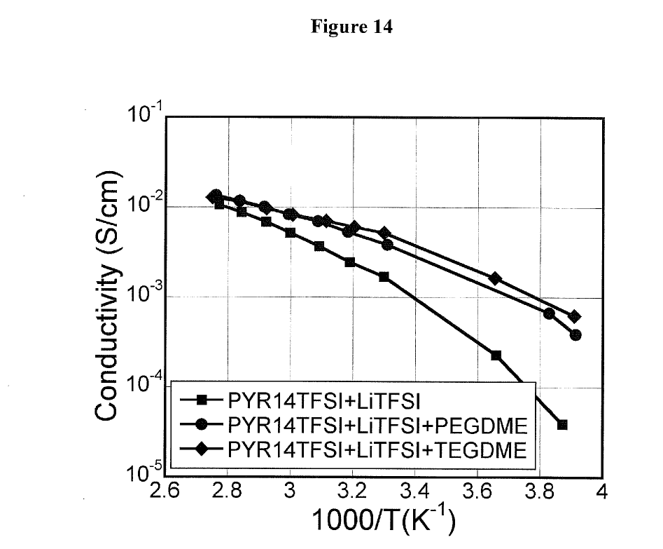

FIG. 14 presents the ionic conductivity as a function of temperature for PYR₁₄TFSI+LiTFSI+polymer additive ternary electrolytes as well as for a PYR₁₄TFSI+LiTFSI binary mixture. We note that there is a slight difference of LiTFSI concentration (moles-LiTFSI/kg-solution) between the ternary electrolyte and the PYR₁₄TFSI+LiTFSI binary mixture, but this difference does not account for the significantly higher ionic conductivity of the ternary electrolyte. The PYR₁₄TFSI+LiTFSI binary mixture exhibited relatively high ionic conductivity at temperatures above room temperature (RT) and a drastic drop of the ionic conductivity was observed at lower temperatures <0° C. which is probably due to the formation of a crystalline phase in the vicinity of −10° C. [14]. The incorporation of polymer additive (PEGDME and TEGDME) into PYR₁₄TFSI+LiTFSI binary mixtures resulted in a significant increase of ionic conductivity at temperatures as low as about −18° C. (lowest temperature in our test set-up). The increase of the ionic conductivity at low temperatures may be attributed to the suppression of formation of a crystalline phase in the ternary electrolyte due to the presence of the polymer additive. In addition, the decreased viscosity resulting from introducing the polymer additive to the ternary electrolyte is partially responsible for the increase of ionic conductivity of the ternary electrolytes compared to that of the PYR₁₄TFSI+LiTFSI binary mixtures.

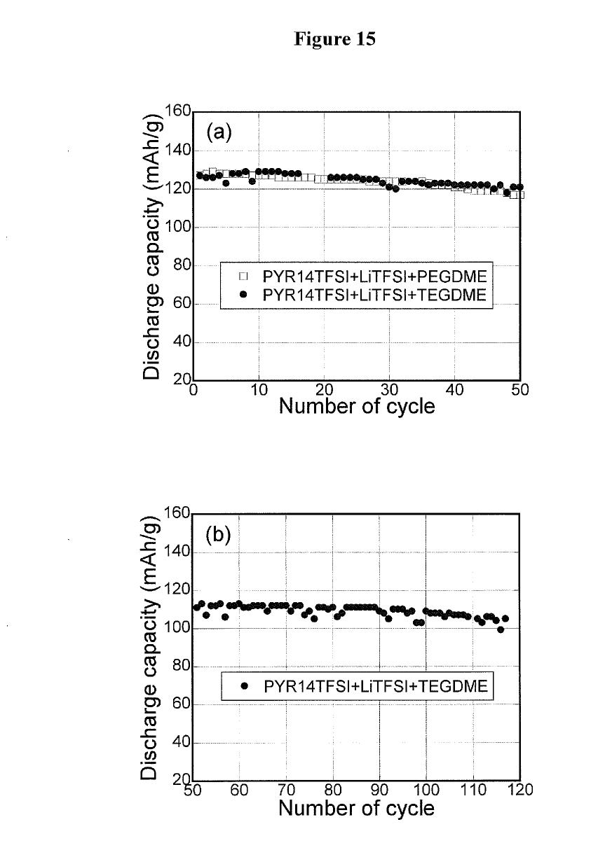

FIG. 15 shows the discharge capacity behavior of Li/LiFePO₄ cells containing PYR₁₄TFSI+LiTFSI+polymer additive ternary electrolytes cycled at the 0.2 C rate at RT. In a previous work we demonstrated that a Li/LiFePO₄ cell with P(EO)₁₀LiTFSI+PYR₄TFSI polymer electrolyte delivers about 134 mAh/g at 0.02 C rate at 20° C. [15]. In this study a specific capacity of 129 mAh/g, corresponding to 75.9% of theoretical capacity, was obtained at a relatively high discharge rate of 0.2 C at RT. As shown in FIG. 15(a) the cycling performance of both cells appears to be almost identical up to the 30^{th} cycle showing an initial small increase, followed by stable behavior. Both cells with PEGDME or TEGDME showed a stable discharge performance up to at least the 50^{th} cycle with a capacity fading rate of 0.15%/cycle (PEGDME) and 0.09%/cycle (TEGDME). After the 50^{th} cycle the charge voltage limit of the Li/PYR₁₄TFSI+LiTFSI+TEGDME/LiFePO₄ cell was reduced and the subsequent cycling behavior of Li/PYR₁₄TFSI+LiTFSI+TEGDME/LiFePO₄ cell tested in the voltage range of 2<V<3.7 is presented in FIG. 15(b). The lowered charge voltage limit from 4V to 3.7V resulted in a decrease of discharge capacity from 129 mAh/g to 113 mAh/g, while the discharge efficiency (defined as (discharge capacity/charge capacity)×100) increased from 91% (for 4.0V) to ˜98% (for 3.7V). The cell showed good cycling performance with a capacity fading rate of 0.15%/cycle over the following 67 cycles from the 51^{st} to 117^{th} cycle.

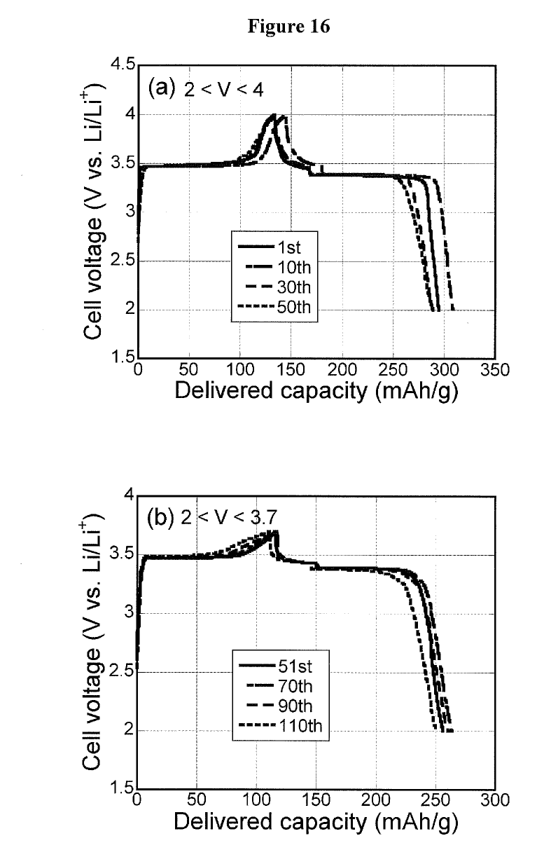

FIG. 16 displays selected voltage profiles of Li/PYR₁₄TFSI+LiTFSI+TEGDME/LiFePO₄ cells cycled at cut-off voltage limits of (a) 2<V<4 and (b) 2<V<3.7 as for the cell shown in FIG. 4. A typical charge/discharge voltage behavior of the LiFePO₄ cathode that shows a plateau in the vicinity of 3.5V (charge) and 3.4V (discharge) (vs. Li/Li⁺) was observed. It is found that the charge/discharge process is reversible at least for the duration of this test showing constant charge and discharge voltage behavior. The ohmic drop during discharge exhibited a slight difference depending on the charge cut-off voltage as follows: 0.06-0.08V for 2<V<4 and 0.04-0.05V for 2<V<3.7.

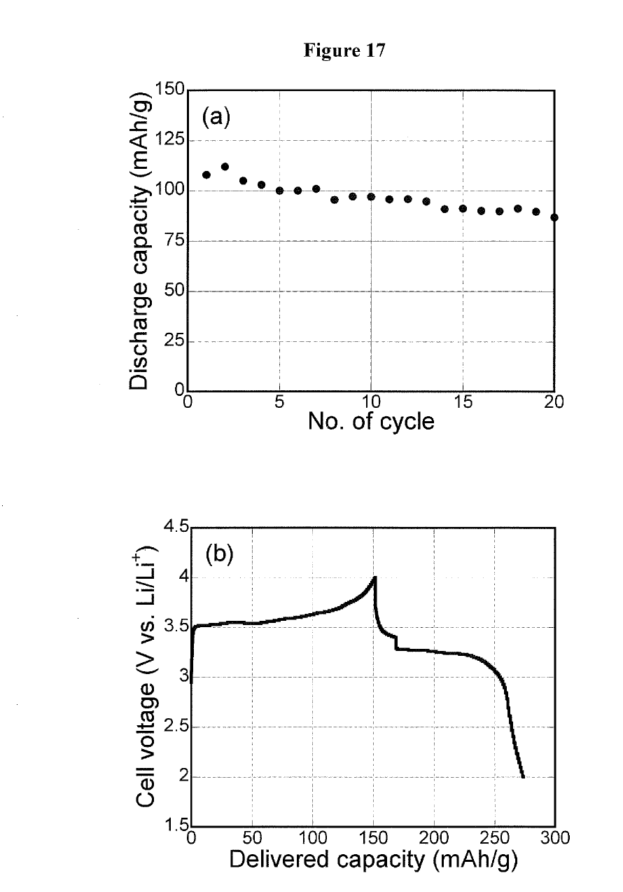

FIG. 17(a) shows the cycling performance of a Li/PYR₁₄TFSI+LiTFSI+TEGDME/LiFePO₄ cell conducted at 0.023 mA/cm² (0.1 C rate) at −1.0 C. Quite interestingly, the cell delivers 112 mAh/g, corresponding to 65.8% of theoretical capacity, which is comparable to the discharge capacity of a LiFePO₄ cell with a polymer electrolyte at 0.2 C at 40° C. [16], and shows promising discharge capability with a capacity fading rate of 1.23%/cycle over 20 cycles at a relatively high rate of 0.1 C at a fairly low temperature. FIG. 17(b) presents the voltage profile of the cell for the 2^{nd} cycle shown in FIG. 17(a). The charge and discharge plateaus shifted slightly toward higher (from 3.50V to 3.55V) and lower (from 3.4 to 3.25V) voltages, respectively, and the change is apparent in the discharge plateau. In addition, the shape of the voltage profile at −1.0 C differs from that for the cell tested at RT. The ohmic drop on discharge was about 0.1V, which is larger than that for the cell operated at RT shown in FIG. 16(a).

As demonstrated above, low molecular weight polymer additives such as PEGDME and TEGDME have been successfully incorporated into PYR₁₄TFSI+LiTFSI mixtures as electrolytes in Li/FePO₄ cells. The resulting PYR₁₄TFSI+LiTFSI+polymer additive (PEGDME or TEGDME) ternary electrolytes exhibited relatively high ionic conductivity as well as remarkably low viscosity over a wide temperature range compared to PYR₁₄TFSI+LiTFSI binary electrolytes. It has also been found that Li/LiFePO₄ cells containing the two different polymer additives showed very similar discharge capacity behavior, and exhibit good cyclability at RT and −1.0° C. A Li/PYR₁₄TFSI+LiTFSI+TEGDME/LiFePO₄ cell exhibits good discharge capability at fairy high current densities over a wide temperature range (−1.0 to 25° C.). As a consequence, PYR₁₄TFSI+LiTFSI+polymer additive (PEGDME and TEGDME) ternary mixtures can serve as electrolytes for Li/LiFePO₄ cells operating over a wide temperature range, and are thus far less prone to overheating as is the case of prior art ionic liquid electrolytes.

By way of summary, the inventors have shown that the Li/PYR₁₄TFSI+LiTFSI+PEGDME/TEGDEM compositions of this invention provide a thermally stable electrolyte for use in lithium containing batteries which electrolyte is more thermally stable and safe than the electrolyte compositions currently in use. In the case of Li metal electrodes as used in non rechargeable cells, the electrolyte of this invention may be readily substituted for those currently in use. To date, because of the drawbacks associated with the use of lithium metal alone as the negative electrode in rechargeable batteries, the use of such lithium metal electrodes has not been practical. However, with the electrolytes of this invention, the use of lithium metal alone as the negative electrode is enabled, where with such a Li metal containing battery cell, repeated cycling is possible without the formation of dendrites during recharge. Finally, as has been demonstrated for more conventional positive electrode materials such as LiFePO₄, the electrolyte of this invention may be used effectively, while providing improved safety, thermal and performance benefits.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

### REFERENCES

[1] Y. Katayama, T. Morita, M. Yamagata, and T. Miura, Electrochemistry (Tokyo, Jpn.), 71, 1033 (2003)
[2] P. C. Howlett, N. Brack, A. F. Hollenkamp, M. Forsyth, and D. R. MacFarlane, J. Electrochem. Socl, 153, A595 (2006)
[3] J. H. Shin and E. J. Cairns, J. Power Sources, 177 (2008) 537
[4] M. Ishikawa, T. Sugimoto, M. Kikuta, E. Ishiko, M. Kono, J. Power Sources 162 (2006) 658.
[5] D. R. MacFarlane, P. Meakin, N. Amini, M. Forsyth, J. Phys.: Condens. Matter 13 (2001) 8257.
[6] W. A. Henderson, S. Passerini, Chem. Mater. 16 (2004) 2881.
[7] K. Hayamizu, Y. Aihara, Electrochim. Acta 49 (2004) 3397.
[8] H.-S. Ryu, H.-J. Ahn, K.-W. Kim, J.-H. Ahn, K.-K. Cho, T.-H. Nam, J.-U. Kim, G.-B. Cho, J. Power Sources 163 (2006) 201.
[9] J. H. Shin, Y. T. Lim, K. W. Kim, H. J. Ahn, J. H. Ahn, J. Power Sources 107 (2002) 103.
[10] H. S. Ryu, H. J. Ahm, K. W. Kim, J. H. Ahn, J. Y. Lee, E. J. Cairns, J. Power Sources 140 (2005)365.
[11] D. Marmorstein, T. H. Yu, K. A. Striebel, F. R. McLamon, J. Hou, E. J. Cairns, J. Power Sources, 89 (2000) 219.
[12] H. Tokuda, S. Tsuzuki, M. A. B. H. Susan, K. Hayamizu, M. Watanabe, J. Phys. Chem. B110 (2006) 19593.
[13] J. Saint, A. S. Best, A. F. Hollenkamp, J. Kerr, J. H. Shin, M. M. Doeff, J. Electrochem. Soc. 155 (2008) A172.
[14] J. H. Shin, E. J. Cairns, J. Electrochem. Soc. 155 (2008) A368.
[15] J. H. Shin, W. A. Henderson, C. Tizzani, S. Passerini, S. S. Jeong, K. W. Kim, J. Electrochem. Soc. 153 (2006) A1649.
[16] K. Hanai, T. Maruyama, N. Ilianishi, A. Hirano, Y. Takeda, O. Yamamoto, J. Power Sources 178 (2008) 789.

We claim:

1. An electrolyte mixture comprising:
a thermally stable ionic liquid;
a low molecular weight polymer having an ethylene oxide chain; and
a lithium salt.

2. The mixture of claim 1, wherein the mixture has an ionic conductivity that is equal to or more than about 2.9×10⁻³ S/cm at 29° C.

3. The mixture of claim 1, wherein the ionic liquid comprises an organic cation and an inorganic anion.

4. The mixture of claim 3, wherein the organic cation features at least one of the following characteristics: high ionic conductivity, thermal stability, and wide electrochemical stability.

5. The mixture of claim 3, wherein the organic cation comprises a bulky asymmetrical structure.

6. The mixture of claim 5, wherein the organic cation is selected from the group consisting of N-methyl-N-alkyl-pyrrolidinium, N-methyl-N-alkyl-pyridinium, N-methyl-N-alkyl-piperidinium, N-methyl-N-alkyl-imidazolium, N-methyl-N-alkyl-phosphonium, N-methyl-N-alkyl-Guanidinium, N-methyl-N-alkyl-Isouronium, N-methyl-N-alkyl-Thiouronium, and N-methyl-N-alkyl-ammonium.

7. The mixture of claim 3, wherein the inorganic anion is an imide having a large electronic delocalization and a low melting temperature.

8. The mixture of claim 3, wherein the inorganic anion is selected from the group consisting of trifluoromethanesulfonate, bis(trifluoro methane sulfonyl)imide, bis(trifluoro methane sulfonyl)amide, hexafluorophosphate, tetrafluoroborate, tetraperchlorate, bisperfluoroethylsulfonyl imide.

9. The mixture of claim 1, wherein the polymer has at least one of the following characteristics: aproticity, inertness, good solvent properties, and retains a low viscosity of the ionic liquid containing mixture.

10. The mixture of claim 9, wherein the polymer is a glyme.

11. The mixture of claim 10, wherein the glyme is selected from the group consisting of poly(ethylene glycol) dimethyl ether (polyglyme, PEGDME), tetra(ethylene glycol) dimethyl ether (tetraglyme, TEGDME), tri(ethylene glycol) dimethyl ether (triglyme).

12. The mixture of claim 1, wherein the low molecular weight polymer has a weight-average molecular weight of about 75 to about 2000.

13. The mixture of claim 12, wherein the low molecular weight polymer has a weight-average molecular weight of about 100 to about 1000.

14. The mixture of claim 13, wherein the low molecular weight polymer has a weight-average molecular weight of about 250 to about 500.

15. The mixture of claim 1, wherein a mass ratio of the polymer to the ionic liquid is about 0.01 to about 10.0.

16. The mixture of claim 1, wherein the lithium salt has at least one of the following characteristics: good ionic conductivity, thermal stability, and oxidation resistance.

17. The mixture of claim 1, wherein the lithium salt is at least one compound selected from the group consisting of LiPF₆, LiBF₄, LiClO₄, LiCF₃SO₃, LiN(CF₃SO₂)₂, LiSbF₆, LiAsF₆, LiN(CF₃CF₂SO₂)₂, (C₂H₅)₄NBF₄, (C₂H₅)₃CH₃NBF₄ and LiI.

18. The mixture of claim 1, wherein the ratio of moles of lithium salt to kg of ionic liquid is about 0.01 m to about 3.0 m.

19. A lithium battery comprising the mixture of claim 1, a positive electrode, and a lithium negative electrode.

20. The lithium battery of claim 19 wherein the lithium negative electrode is selected from the group comprising Li, Li(C)₆, Li—Al, Li—Sn and Li—Si.

21. The lithium battery of claim 20 wherein the lithium negative electrode comprises lithium metal.

22. A method of making a mixture for uses as an electrolyte in a lithium ion battery comprising:
(a) providing a thermally stable ionic liquid;
(b) providing a polymer having an ethylene oxide chain capable of being adsorbed into a lithium metal;
(c) providing a lithium salt; and thereafter,
(d) mixing the ionic liquid, the polymer, and the lithium salt.

23. A lithium ion battery comprising:
(a) a mixture, wherein the mixture comprises a thermally stable ionic liquid, a polymer having an ethylene oxide chain, a lithium salt;
(b) a lithium negative electrode; and
(c) a positive electrode.

24. The lithium ion battery of claim 23 wherein the battery is rechargeable.

25. The lithium ion battery of claim 24 wherein the lithium negative electrode comprises lithium metal.

26. The lithium ion battery of claim 24 wherein the positive electrode comprises sulfur.

27. A method of making a rechargeable lithium ion battery comprising:
(a) providing a mixture comprising a thermally stable ionic liquid, a polymer having an ethylene oxide chain, a lithium salt;
(b) providing a positive electrode;
(c) providing a lithium negative electrode;
(d) providing a cell housing; and
(e) assembling the mixture, the positive electrode, and the lithium negative electrode into the cell housing.

28. The method of claim 26 wherein the lithium negative electrode comprises lithium metal.

29. The method of claim 27 wherein the positive electrode comprises sulfur.
